(19) United States
(12) Patent Application Publication
(10) Pub. No.: US 2016/0261225 A1
(43) Pub. Date: Sep. 8, 2016

(54) System for Holding at Least One Solar Panel on a Solar Module and Solar Module Comprising Same

(71) Applicant: Exosun, Martillac (FR)

(72) Inventor: François PAPONNEAU, Cestas (FR)

(73) Assignee: EXOSUN, Martillac (FR)

(21) Appl. No.: 15/030,460

(22) PCT Filed: Oct. 20, 2014
(86) PCT No.: PCT/FR2014/052660

§ 371 Date: Apr. 19, 2016

(30) Foreign Application Priority Data
Oct. 25, 2013 (FR) 1360466

(51) Int. Cl. H02S 20/32; F24J 2/52

(52) U.S. Cl. CPC H02S 20/32; F24J 2/5258; F24J 2/5262

(57) ABSTRACT

A mounting system for holding at least one solar panel on a solar module of a solar tracker includes at least one beam having a longitudinal elongate opening and a bearing surface against which the at least one solar panel is intended to bear, and at least one clamping assembly that includes a clamp defining a housing designed to accept an edge of the solar panel against the bearing surface, a threaded clamping element collaborating with the clamp and a connecting element that connects the threaded clamping element with the beam collaborating with the longitudinal elongate opening, the longitudinal elongate opening being produced on a lateral side of the beam adjacent to the bearing surface.

The invention relates to a mounting system for holding at least one solar panel on a solar module of a solar tracker and to a solar module comprising same.

At the present time, in order to install a collection of solar panels on a solar module of a solar tracker, as illustrated, for example, in document U.S. Pat. No. 6,672,018, a mounting system is used for this purpose. This mounting system comprises a set of beams comprising a longitudinal elongate opening which gives the beams a U-shaped cross section, the tops of the branches of the U defining a bearing surface against which, at the time of mounting, the solar panels bear. The latter are held firmly against the edges of the longitudinal elongate opening using a clamping assembly. However, the use of such a U-section beam entails providing, in the clamping assembly, an arrangement that prevents the lateral walls of the beam that form the branches of the U from parting and, on the other hand, that prevents these same lateral sides that form the branches of the U from moving closer together, at the time of clamping. That leads to the creation of a clamping assembly that is relatively complex to produce and to install. Furthermore, between two clamping assemblies, the lateral walls of the beam that form the branches of the U are not held apart, and are therefore free to deform when the collection of solar panels mounted on this beam is subjected to loadings caused for example by the wind. These mechanical stresses to which the beam is subjected have the effect of causing the latter to deform toward a neutral axis of the beam, thereby weakening it.

It is an object of the invention to provide a mounting system for holding at least one solar panel on a solar module of a solar tracker that is simple to produce and to use while at the same time enhancing the strength of the beams when the at least one solar panel is subjected to external mechanical stress loadings.

To this end, the invention provides a mounting system for holding at least one solar panel on a solar module of a solar tracker comprising at least one beam comprising a longitudinal elongate opening and a bearing surface against which the at least one solar panel is intended to bear, and at least one clamping assembly comprising a clamp defining a housing designed to accept an edge of the solar panel against the bearing surface, a threaded clamping element collaborating with the clamp and a connecting element that connects the threaded clamping element with the beam collaborating with the longitudinal elongate opening, the longitudinal elongate opening being produced on a lateral side of the beam adjacent to the bearing surface.

Advantageously, although optionally, the mounting system according to the invention has at least one of the following additional technical features:

the tail of the clamp has a length shorter than a thickness of the solar panel with which the clamp is intended to collaborate during use;

the connecting element comprises hook-forming means arranged in such a way as to collaborate with the longitudinal elongate opening;

the hook-forming means comprise an upper hook collaborating with an upper edge of the longitudinal elongate opening;

the hook-forming means comprise a lower hook collaborating with a lower edge of the longitudinal elongate opening;

the lower edge comprises a lip projecting from the lateral side toward the inside of the beam; and

the connecting element comprises a through-opening for accepting the threaded clamping element.

The invention also provides a solar module comprising at least one solar panel as well as a mounting system for holding the at least one solar panel that has at least one of the abovementioned technical features.

Further features and advantages of the invention will become apparent during the course of the following description of one embodiment of the invention. In the attached drawings:

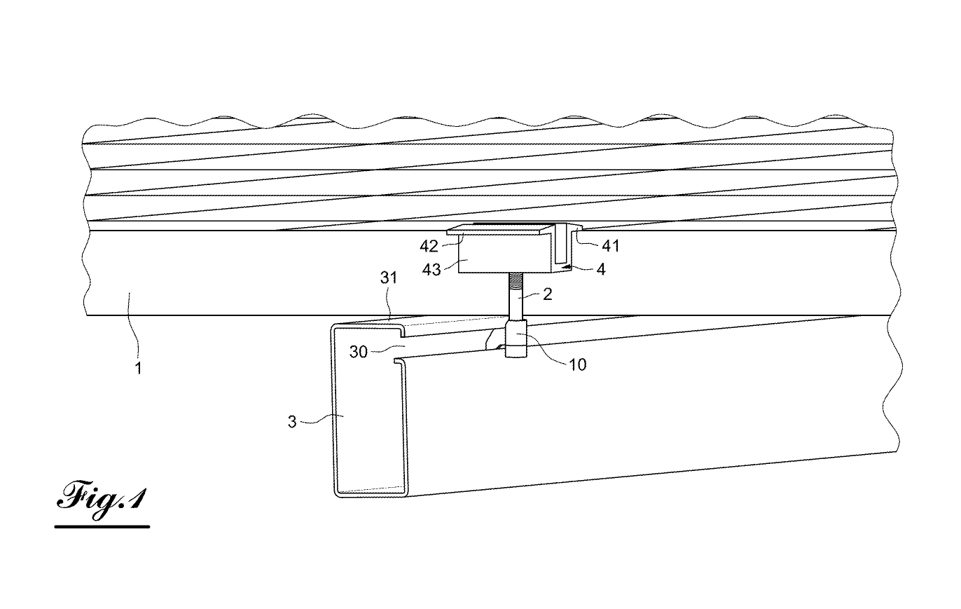

FIG. 1 is a three-dimensional view of one embodiment of a mounting system for holding at least one solar panel according to the invention, holding a solar panel;

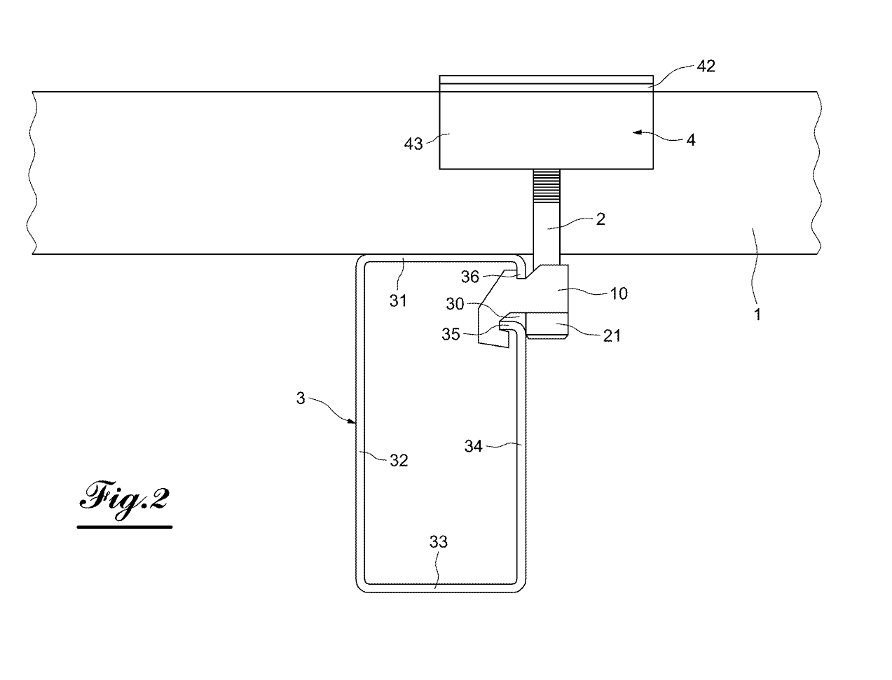

FIG. 2 is a side view of the mounting system of FIG. 1;

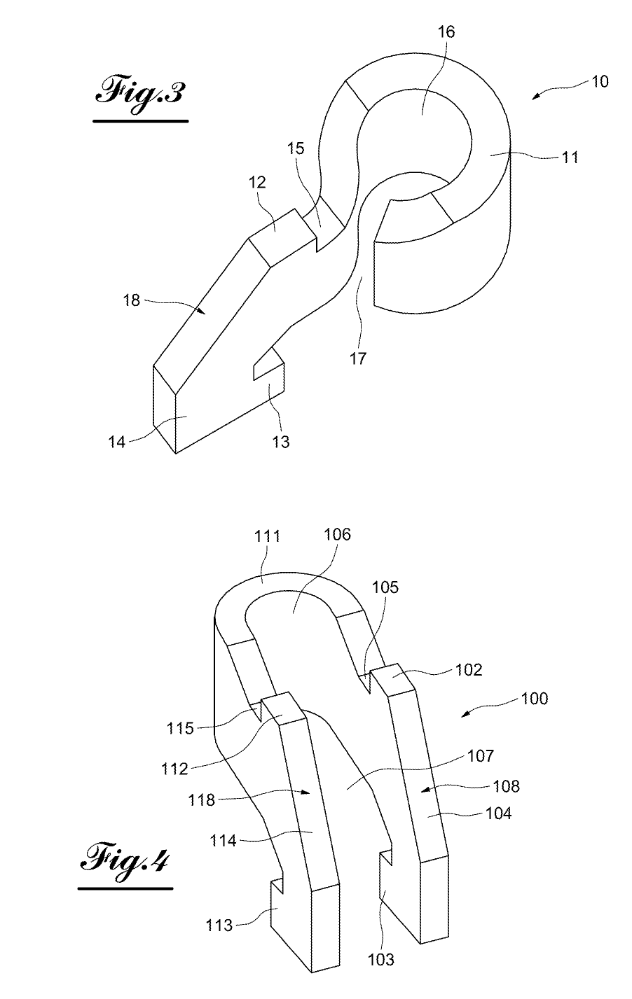

FIG. 3 is a three-dimensional view of a first embodiment of a connecting element for the mounting system according to the invention of FIGS. 1 and 2;

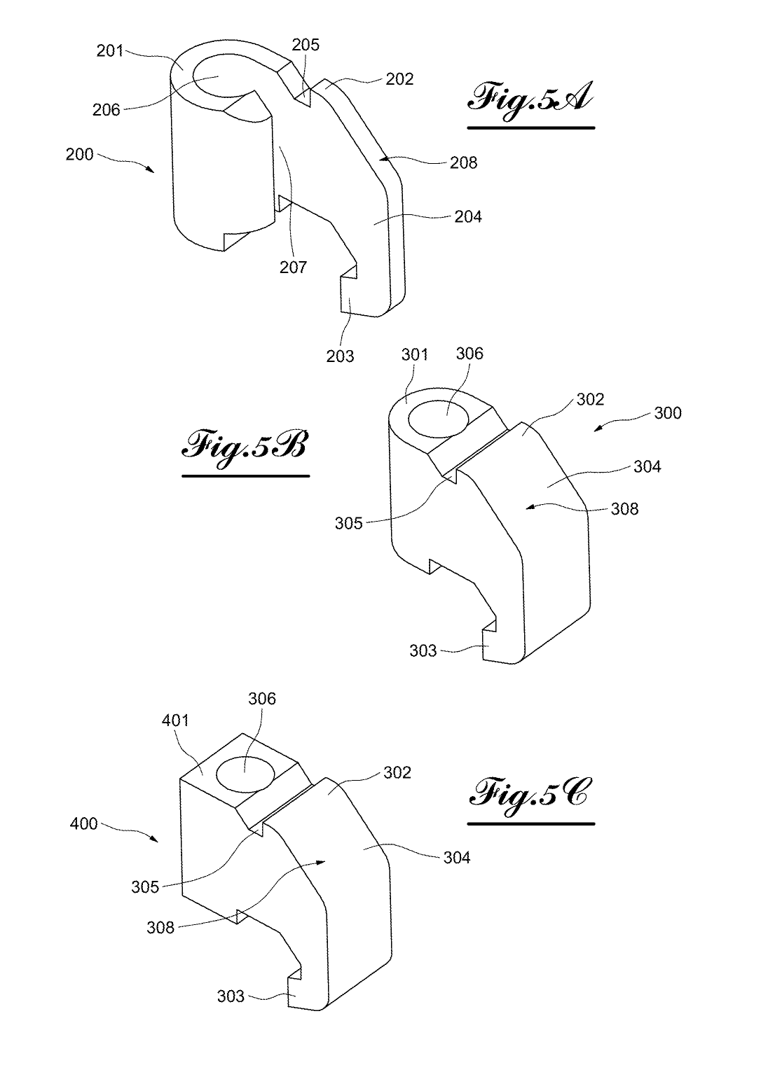

FIGS. 4, 5A to 5D are three-dimensional views of alternative forms of embodiment of connecting elements for a mounting system according to the invention of FIGS. 1 and 2;

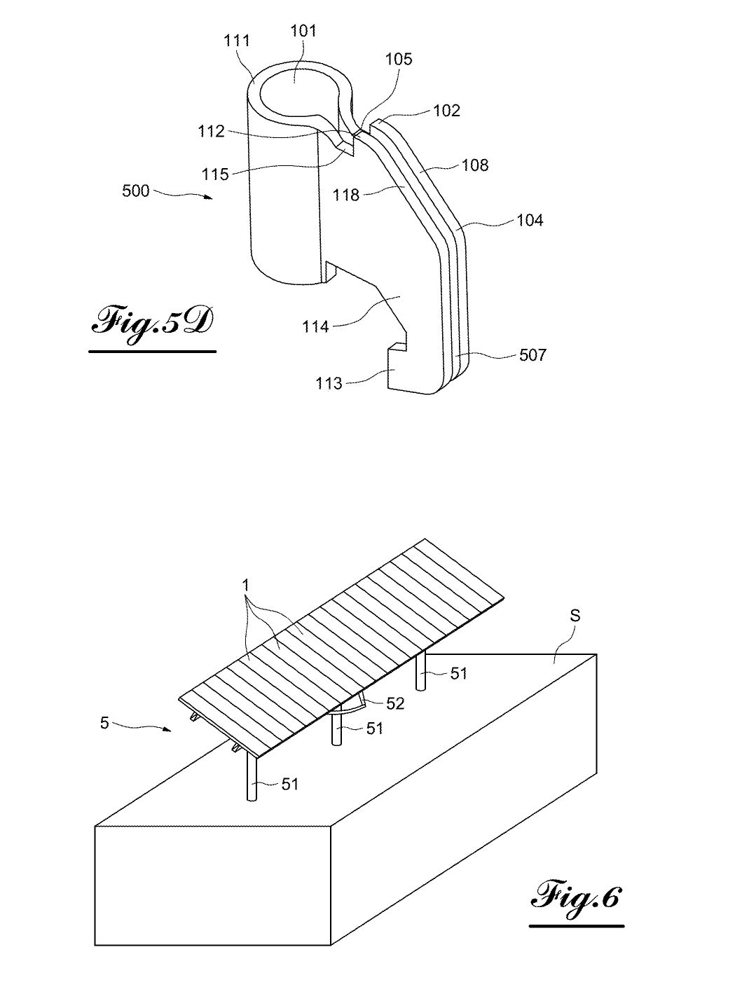

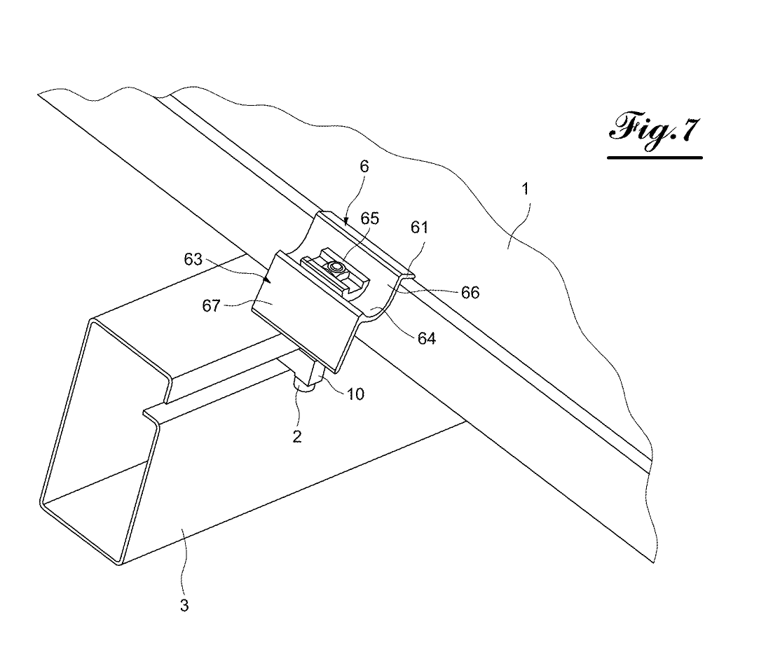

FIG. 6 is a three-dimensional view of a solar module for a solar tracker comprising a collection of solar panels and a mounting system for holding the solar panels according to the invention;

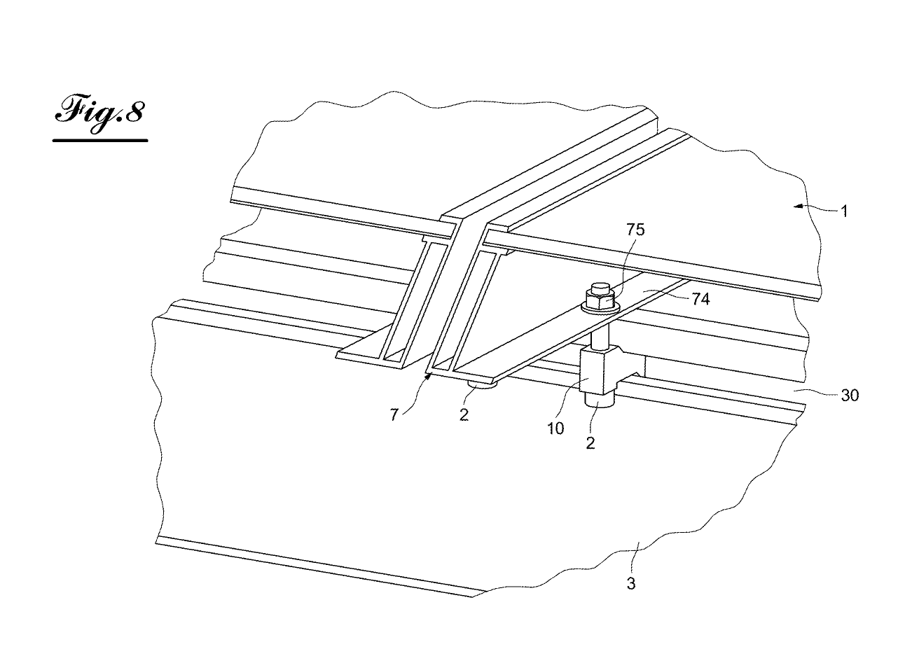

FIG. 7 is a three-dimensional view of an alternative form of embodiment of the mounting system for holding at least one solar panel according to the invention, holding a solar panel; and

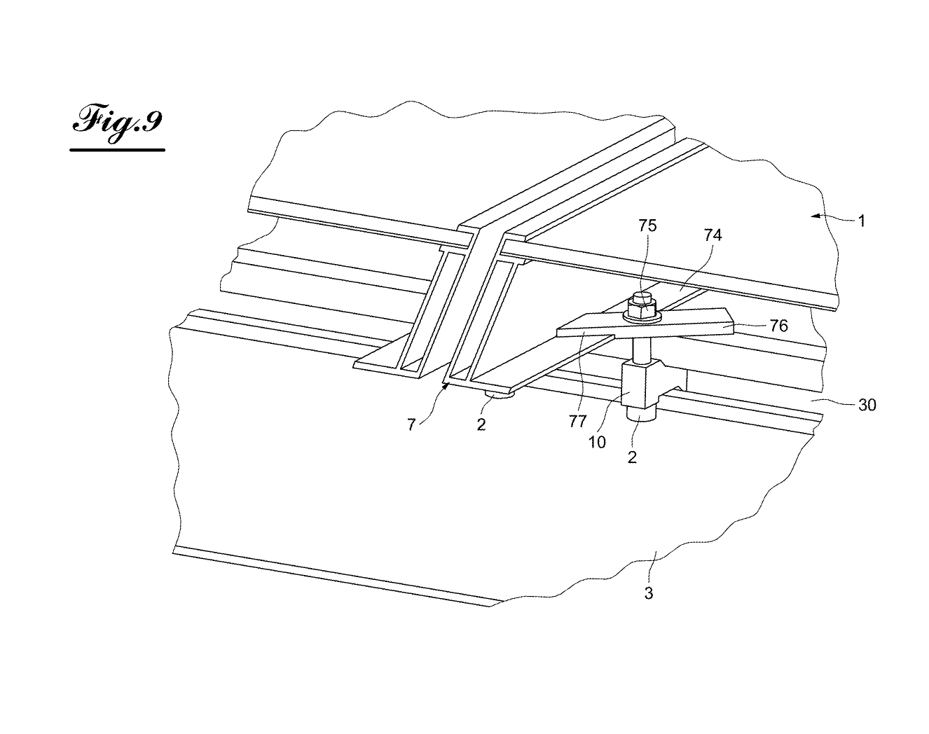

FIGS. 8 and 9 are three-dimensional views of other alternative forms of embodiment of the mounting system for holding at least one solar panel according to the invention, holding a solar panel.

A solar module 5, like the one illustrated in FIG. 6, is positioned on the ground S and for that purpose comprises a base 51 fixed to this ground S. The base 51 supports an orientation mechanism 52 that orientates the solar module. Furthermore, the solar module 5 comprises solar radiation processing means, here made up of a series of solar panels 1 which are held on the solar module 5 using a mounting system according to the invention that will now be described in greater detail. As an alternative, the solar module is a fixed structure.

With reference to FIGS. 1 and 2, a mounting system for holding at least one solar panel on a solar module of a solar tracker according to the invention comprises at least one beam 3. This beam in this instance is a girder made from a sheet of metal that has been profiled using rollers (by the technique more commonly known as “roll-forming”) and which has a rectangular overall section. The beam 3 is hollow. It comprises two lateral sides 32 and 34 extending some distance facing one another and joined together by an upper side 31 and a lower side 33. In general, the cross-sectional dimensions of the lateral sides 32, 34 are greater than the cross-sectional dimensions of the upper 31 and lower 33 sides. One of the lateral sides 34 comprises a longitudinal elongate opening 30 extending parallel to and at some distance from the upper side 31. This longitudinal elongate opening 30 comprises an upper edge 36 and a lower edge 35. The lower edge 35 comprises a lip projecting from the lateral side 34 toward the inside of the beam 3. In an alternative form of embodiment, the longitudinal elongate opening 30 is produced in the other lateral side 32. That gives the beam 3 a G-shaped cross section. As an alternative form of embodiment of the beam 3, the lateral sides 32 and the lower side 33 have any orientation and/or any shape.

The upper side 31 of the beam 3 forms a bearing surface against which, when the mounting system according to the invention is in use, the solar panel 1 bears. Creating a longitudinal elongate opening 30 in one of the lateral sides 32, 34 makes it possible to obtain on the upper side 31 a bearing surface that is continuous and maximized in relation to the dimensions of the beam 3. Such a situation contributes to the stability of the solar panel thus held bearing against the upper side 31 by the mounting system for holding at least one solar panel according to the invention. In addition, the ability of the beam 3 to resist deformation toward a neutral axis of said beam is enhanced when the latter experiences loadings caused by the weather conditions such as the wind.

In order to maintain this pressure on the surface created by the upper side 31 of the beam 3, the mounting system for holding at least one solar panel according to the invention comprises a clamp 4 which is in the overall shape of a T in cross section comprising a tail 43 surmounted by a cap, the lips 42,41 of which extend perpendicular to the tail 43. In one embodiment illustrated here, the tail 43 is U-shaped in cross section. The base of the tail 43 of the clamp 4 has at least one threaded orifice able to accept a threaded clamping element 2. For example, this clamping element 2 is a screw of the hexagon socket head type. The clamping element 2 comprises a head 21 at one of its ends and a screw thread at the other end. In addition, the mounting system for holding at least one solar panel according to the invention comprises a connecting element 10 that connects the threaded clamping element 2 to the beam 3. As illustrated in FIGS. 1 and 2, the connecting element 10 collaborates with the longitudinal elongate opening 30. The clamp 4 allows two adjacent solar panels to be held in place simultaneously.

One alternative form of embodiment of the clamp will now be described with reference to FIG. 7. The clamp 6 comprises a tail 63 comprising in succession an upper part 66, a U-shaped cut 64 and a lower tab 67. The tab 67 allows the clamp 6 to be held bearing against the bearing surface on the upper side 31 so as to prevent it from tilting when tightened. The clamp 6 further comprises a lip 61 extending perpendicular to the upper part 66 of the tail 63 and surmounting the latter. The lip 61 and the tail 63 define a housing designed to accept an edge of the solar panel 1 against the bearing surface of the upper side 31. At the bottom of the cup 64, the tail 63 of the clamp 6 has at least one orifice able to accept the threaded clamping element 2. A nut 64 is intended to collaborate with the threaded part of the clamping element 2. This nut 65 comprises a lower surface that has a shape that complements that of the U-shaped cup 64 which houses said nut 65 when the mounting system according to the invention is in use. That further allows the clamp 6 to orient itself freely so as to clamp solar panels of varying thicknesses.

Another alternative form of embodiment of the mounting system according to the invention is illustrated in FIG. 8. In this alternative form of embodiment, the clamp has disappeared. The solar panel 1 comprises a side 7 forming the edge of the solar panel. This side is formed of a profile which at its base has a lip 74 comprising a series of orifices, each one intended to accept a threaded clamping element 2. There are at least as many orifices as there are beams 3 that the side 7 of the solar panel 1 will cover during use. In order to clamp, a nut 75 (and also possibly a washer) is able to collaborate with the threaded part of the clamping element 2.

In this alternative form of embodiment, the presence of the series of orifices in the lip 74 dictates the position and number of beams 3 to use. In order to allow freedom of positioning, and a freedom in the number of beams 3 to be used, the use of a clamp 76 for clamping the lip 74 to the beam 3 as illustrated in FIG. 9 is envisioned. This clamp 76 is of elongate shape and comprises an orifice able to accept a threaded clamping element 2. A first part of the clamp bears against the bearing surface of the upper side 31 of the beam 3. This first part extends from the orifice that accepts the clamping element 2 as far as a first end of the clamp 76. A second part of the clamp 76 collaborates with the lip 74 of the side 7 of the solar panel 1 in order to keep it pressed against the bearing surface of the upper side 31 of the beam 3. The second part extends from the orifice accepting the clamping element 2 as far as a second end of the clamp 76. The second end comprises a rebate 77 designed to accommodate the lip 74. In order to perform clamping, a nut 75 (and also possibly a washer) can collaborate with the threaded part of the clamping element 2.

The connecting element 10 of the mounting system for holding at least one solar panel according to the invention will now be described in greater detail with reference to FIG. 3. The connecting element 10 comprises two adjacent parts. The first adjacent part 11 is formed of a body 11 in which there has been made a through-opening 16 for accepting the threaded clamping element 2. The first adjacent part 11 is a cylinder of revolution overall and the through-opening 16 is coaxial with this cylinder of revolution overall shape. Furthermore, the first adjacent part 11 comprises a slot 17 extending along a generatrix of the cylinder of revolution overall shape of the first adjacent part 11. At one of the edges of this slot 17, the connecting element 10 comprises the second adjacent part 14. This second adjacent part 14 projects radially away from the center of the first adjacent part 11. This second adjacent part 14 is of planar overall shape and oriented parallel to an axis of the cylinder of revolution overall shape of the first adjacent part 11. What is more, a mid plane of the second adjacent part 14 passes through this axis of the cylinder of revolution overall shape of the first adjacent part 11. The second adjacent part 14 comprises hook-forming means. These hook-forming means comprise an upper hook 12,15 comprising a hook throat 15 and a tip 12. During use of the mounting system for holding at least one solar panel according to the invention as illustrated in FIGS. 1 and 2, the upper hook 12,15 collaborates with the upper edge 36 of the longitudinal elongate opening 30 of the beam 3, the upper edge 36 being housed pressing against the hook throat 15 while the tip 12 presses against an internal lateral surface of the edge 36 of the longitudinal elongate opening 30 of the beam 3.

The second adjacent part 14 furthermore comprises an inclined surface 18 adjacent to the tip 12 of the upper hook. This inclined surface 18 connects the upper hook 12,15 to a lower hook 13. The lower hook 13, when the mounting system for holding at least one solar panel according to the invention is in use, collaborates with the lower edge 35 of the longitudinal elongate opening 30 of the beam 3, as illustrated in FIGS. 1 and 2.

One method of using and implementing the mounting system for holding at least one solar panel according to the invention that has just been described will now be described.

The beam 3 is positioned on the solar module first of all. Next, the connecting element 10 is fitted into the longitudinal elongate opening 30. There are at least four possible ways in which to fit the connecting element 10 into the longitudinal elongate opening 30 of the beam 3.

In a first method, the connecting element 10 is slipped into the longitudinal elongate opening 30 from one end of the beam 3. Thus, the connecting element 10 is put in position on the beam 3 by sliding it along the longitudinal elongate opening 30 with the upper hook collaborating with the upper edge 36 of the longitudinal elongate opening 30 and sliding along the latter, the lower hook 13 collaborating with the lower edge lip 35 by sliding along that.

In a second method, the second adjacent part 14 of the connecting element 10 is introduced directly in the correct position into the longitudinal elongate opening 30, the mid plane of the second adjacent part 14 being parallel to said longitudinal elongate opening 30. Once the second adjacent part 14 has been introduced into the longitudinal elongate opening 30, an operator turns the connecting element through a quarter-turn so as to bring the mid plane of the second adjacent part 14 perpendicular to the longitudinal elongate opening 30, the upper hook 12,15 coming to collaborate with the upper edge 36 and the lower hook 13 coming to collaborate with the lower edge 35 of the longitudinal elongate opening 30.

A third method is to introduce the lower hook 13 into the longitudinal elongate opening 30 first of all, with the mid plane of the second adjacent part 14 perpendicular to the longitudinal elongate opening 30. The lower hook 13 then comes into contact and into engagement with the lip of the lower edge 35 of the longitudinal elongate opening 30. Next, the operator tilts the connecting element so as first of all to bring the inclined surface 18 into contact with the upper edge 36 of the longitudinal elongate opening 30. By continuing the tilting movement, the connecting element 10 is clipped into the longitudinal elongate opening 30 by causing the tip 12 of the upper hook to pass through the longitudinal elongate opening 30. The clip-fastening thus generated causes the upper edge 36 to position itself bearing against the throat of the hook 15 of the upper hook.

A fourth method is to introduce the lower hook 13 into the longitudinal elongate opening 30 first of all with the mid plane of the second adjacent part 14 perpendicular to the longitudinal elongate opening 30. The lower hook 13 enters the inside of the beam 3. The operator continues to introduce the connecting element 10 into the beam 3 through the longitudinal elongate opening 30 until the hook tip 12 passes through the longitudinal elongate opening 30. The operator then makes the hook throat 15 collaborate with the upper edge 36 of the longitudinal elongate opening 30, the upper edge 36 coming to press against the hook throat 15 of the upper hook. Next, the operator tilts the connecting element 10 so as to bring the lip of the lower edge 35 of the longitudinal elongate opening 30 into contact with the lower hook 14.

Once the connecting element has thus been fitted to the beam 3 in the correct position, the threaded clamping element 2 is introduced into the through-opening 16 of the first adjacent part 11 of the connecting element 10. The head 21 of the threaded clamping element positions itself facing the lower hook 13 of the connecting element 10 and pressing against a lower face of the first adjacent part 11. Thus, as illustrated in FIG. 2, the lower edge 35 of the longitudinal elongate opening 30 is held captive in the lower hook 13 of the connecting element 10 by the head 21 of the threaded clamping element 2. That makes the connecting element 10 secure on the beam 3.

Next, the operator fits the T-shaped clamp by causing the threaded orifice provided for that purpose on the base of the tail 43 to collaborate with the threaded end of the threaded clamping element 2. Thus, one of the lips 41,42 defines, with the tail 43, a housing able to accept one edge of the solar panel 1. The solar panel 1 is positioned on the beam 3 in such a way that one of its edges comes into the housing thus defined, on the one hand, and, on the other hand, to bear against the bearing surface of the upper side 31 of the beam 3. Next, all the operator needs to do is to tighten the threaded clamping element 2 so that the edge of the solar panel 1 finds itself sandwiched tightly between one of the lips 41,42 of the T-shaped clamp and the bearing surface on the upper side 31 of the beam 3. In order to ensure that this clamping is perfect, the tail 43 has a dimension between an underside of the lips 41,42 and the end wall of the tail 43 which is less than the thickness of the edge of the solar panel 1 housed in the housing defined by the T-shaped clamp as described previously.

All of these operations are repeated as many times as necessary so as to position the series of solar panels 1 mounted on the solar module 5 as illustrated in FIG. 6.

In an alternative form of embodiment of the mounting system according to the invention, the through-opening 16 has dimensions that allow the clamping element 2 to be retained by friction once this element has been introduced into said through-opening 16. The same is true of the through-openings of the alternative forms of embodiment of the connecting element which are illustrated in FIGS. 4, 5A to 5D.

In another alternative form of embodiment of the mounting system according to the invention, the through-opening 16 is threaded. In that case, the threaded part of the clamping element 2 is screwed into the through-opening 16. The clamp 4 comprises, in the region of its tail 43, not a threaded orifice, but now a plain orifice able to accept, possibly with friction in order to hold it in position during handling, the clamping element 2, the head 21 of the latter being housed in the clamp 4. The same is true of the through-openings of the alternative forms of embodiment of the connecting element which are illustrated in FIGS. 4, 5A to 5D.

Alternative forms of embodiment of the connecting element of the mounting system for holding at least one solar panel according to the invention will now be described with reference to FIGS. 4, 5A to 5D.

In FIG. 4, a first alternative form of embodiment of the connecting element 100 is U-shaped when viewed from above. The first adjacent part 111 that forms the end wall of this U-shape whereas the second adjacent part 104,114 is in two parts, each of the parts forming one branch of the U-shape. As in the embodiment illustrated in FIG. 3, a through-opening 106 is made in the first adjacent part 111 and it is intended to accept the threaded clamping element 2. In addition, as with the previous embodiment of FIG. 3, each of the parts 104 and 114 respectively of the second adjacent part of the connecting element 100 comprises an upper hook 102,105 (and 112,115) comprising a hook throat 105 (and 115) and a tip 102 (and 112). Each of the parts of the second adjacent part of the connecting element 100 comprises an inclined surface 108 (and 118) which is adjacent to the tip 102 (and 112). This inclined surface 108 (and 118) connects the upper hook to a lower hook 103 (and 113). In addition, the two parts 104,114 of the second adjacent part of the connecting element 100 delimit a slot 107. The use of this alternative form of embodiment of the connecting element 100 of the mounting system for holding a solar panel according to the invention is identical to the use and implementation of the embodiment illustrated in FIG. 3.

FIG. 5D illustrates an alternative form of the embodiment of the connecting element 100 of FIG. 4. The connecting element 500 differs from the preceding connecting element 100 in that the parts 104,114 that form the branches of the U are brought closer together and therefore delimit a gap 507. In the extreme, the parts 104,114 are in contact with one another and the gap 507 is nonexistent. As with the previous embodiments, the use and implementation of this alternative form of embodiment of a connecting element 500 is identical to the implementation and use of the connecting element 10 of FIG. 3.

FIG. 5A illustrates a second alternative form of embodiment of a connecting element 200 of the mounting system for holding a solar panel according to the invention. This alternative form of embodiment 200 is very similar to the embodiment of the connecting element 10 of FIG. 3. The first adjacent part 201, with the overall shape of a cylinder of revolution, comprises a through-opening 206 coaxial with the cylinder of revolution overall shape of the first adjacent part 201. A slot 207 extending along one generatrix of the cylinder of revolution overall shape of the first adjacent part 201. At one of the edges of this slot 207, the second adjacent part 204 extends as a projection and has a mid plane parallel to an axis of the cylinder of revolution overall shape of the first adjacent part 201. Here, the second adjacent part 208 extends as a projection from the first adjacent part 201 tangentially. Once again, the second adjacent part 204 comprises an upper hook 202,205 comprising a hook throat 205 and a tip 202. An inclined surface 208 is adjacent to the hook tip 202 and connects the upper hook to a lower hook 203. As with the previous embodiments, the use and implementation of this alternative form of embodiment of a connecting element 200 is identical to the implementation and use of the connecting element 10 of FIG. 3.

FIG. 5B illustrates a third alternative form of embodiment of a connecting element 300 of the mounting system for holding at least one solar panel according to the invention. The connecting element 300 comprises a first adjacent part 301 of cylinder of revolution overall shape in which a through-opening 306 is made coaxially with the cylinder of revolution overall shape of the first adjacent part 301. A second adjacent part 304 extends as a projection radially from the first adjacent part 301. Once again, as with the previous embodiments, this second adjacent part comprises an upper hook 302,305 itself comprising a hook throat 305 and a tip 302. Adjacent to this tip 302, the second adjacent part 304 comprises an inclined surface 308 which connects the upper hook to a lower hook 303. Here, the second adjacent part 304 has a width identical to a diameter of the cylinder of revolution overall shape of the first part 301. Once again, the implementation and use of this alternative form of embodiment of the connecting element 300 is identical to the implementation and use of the preceding alternative forms of embodiment of this connecting element.

Finally, FIG. 5C illustrates a fourth alternative form of embodiment of a connecting element 400 of the mounting system for holding at least one solar panel according to the invention. This alternative form of embodiment 400 of the connecting element differs from the preceding alternative form of embodiment 300 only in that the first adjacent part 401 does not have a cylinder of revolution overall shape but defines a rectangle in cross section.

Another advantage with the mounting system according to the invention which has just been described is that it allows easier access to the clamping element 2 and to the connecting element 10,100,200,300,400,500 because of their lateral positionings on the beam 3.

Of course, it is possible to make numerous modifications to the invention without thereby departing from the scope thereof. For example, the solar panel 1 may be replaced by a mirror.

1.-5. (canceled)

6. A mounting system for holding at least one solar panel on a solar module of a solar tracker comprising
at least one beam comprising a longitudinal elongate opening and a bearing surface against which the at least one solar panel is intended to bear, and at least one clamping assembly comprising a clamp defining a housing designed to accept an edge of the solar panel against the bearing surface,
a threaded clamping element collaborating with the clamp and a connecting element that connects the threaded clamping element with the beam collaborating with the longitudinal elongate opening, the longitudinal elongate opening being produced on a lateral side of the beam adjacent to the bearing surface,
wherein the connecting element includes an upper hook collaborating with an upper edge of the longitudinal elongate opening and a lower hook collaborating with a lower edge of the longitudinal elongate opening.

7. The mounting system according to claim 6, wherein a tail of the clamp has a length shorter than a thickness of the solar panel with which the clamp is intended to collaborate during use.

8. The mounting system according to claim 6, wherein the lower edge comprises a lip projecting from the lateral side toward an inside of the beam.

9. The mounting system according to claim 6 wherein the connecting element comprises a through-opening for accepting the threaded clamping element.

10. A solar module comprising at least one solar panel, and a mounting system for holding the at least one solar panel according to claim 6.
